(19) United States
(12) Patent Application Publication
(10) Pub. No.: US 2025/0047727 A1
(43) Pub. Date: Feb. 6, 2025

(54) Conferencing System Terminal Devices and Corresponding Methods Facilitating Side Calls During Videoconferences

(71) Applicant: Motorola Mobility LLC, Chicago, IL (US)

(72) Inventors: Amit Kumar Agrawal, Bangalore (IN); Krishnan Raghavan, Bangalore (IN); Vignesh Karthik Mohan, Bangalore (IN)

(21) Appl. No.: 18/230,526

(22) Filed: Aug. 4, 2023

(51) Int. Cl. H04L 65/4038; H04L 65/401

(52) U.S. Cl. CPC H04L 65/4038; H04L 65/4015

(57) ABSTRACT

A method in a conferencing system terminal device includes detecting, with one or more processors during a videoconference, a communication device electronically in communication with a plurality of remote electronic devices engaged in the videoconference. The method includes receiving, with a user interface operable with the one or more processors, user input initiating a communication operation at the conferencing system terminal device. In response to the user input, one or more processors of the conferencing system terminal device present a prompt allowing a selection of a subset of the plurality of remote electronic devices for a side call during the videoconference.

### BACKGROUND

### Technical Field

This disclosure relates generally to electronic devices, and more particularly to electronic devices capable of providing video conferencing features.

### Background Art

Many modern electronic devices, including smartphones, tablet computers, and laptop computers, are equipped to engage in videoconferences with other electronic devices across a network. Users employ such devices to communicate with friends, family, and work colleagues. This is especially true during times of pandemic, when people work remotely rather than going to a centralized office. Participants engage videoconferencing to engage in real-time discussions and share electronic content. Videoconferencing additionally offers participants the ability to see other participants via video feeds streamed to the participating electronic devices. It would be advantageous to have an improved methods, systems, and devices to make potential activities in videoconferencing realms more like those available in face-to-face meetings.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 illustrates one explanatory conferencing system in accordance with one or more embodiments of the disclosure.

FIG. 2 illustrates one or more method steps in accordance with one or more embodiments of the disclosure.

FIG. 3 illustrates one or more method steps in accordance with one or more embodiments of the disclosure.

FIG. 4 illustrates one or more method steps in accordance with one or more embodiments of the disclosure.

FIG. 5 illustrates one explanatory method in accordance with one or more embodiments of the disclosure.

FIG. 6 illustrates another explanatory method in accordance with one or more embodiments of the disclosure.

FIG. 7 illustrates one or more method steps in accordance with one or more embodiments of the disclosure.

FIG. 8 illustrates one or more method steps in accordance with one or more embodiments of the disclosure.

FIG. 9 illustrates one or more method steps in accordance with one or more embodiments of the disclosure.

FIG. 10 illustrates one explanatory conferencing system terminal device in accordance with one or more embodiments of the disclosure.

FIG. 11 illustrates one explanatory conferencing system server complex in accordance with one or more embodiments of the disclosure.

FIG. 12 illustrates one or more embodiments of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to receiving, with a user interface of a conferencing system terminal device, user input initiating a communication operation and, in response to the user input, presenting, with one or more processors of the conferencing system terminal device, a prompt allowing a selection of a subset of the plurality of remote electronic devices for a side call during a videoconference. Any process descriptions or blocks in flow charts should be understood as representing modules, segments, or portions of code which include one or more executable instructions for implementing specific logical functions or steps in the process.

Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Embodiments of the disclosure do not recite the implementation of any commonplace business method aimed at processing business information, nor do they apply a known business process to the particular technological environment of the Internet. Moreover, embodiments of the disclosure do not create or alter contractual relations using generic computer functions and conventional network operations. Quite to the contrary, embodiments of the disclosure employ methods that, when applied to electronic device and/or user interface technology, improve the functioning of the electronic device itself by and improving the overall user experience to overcome problems specifically arising in the realm of the technology associated with electronic device user interaction.

It will be appreciated that embodiments of the disclosure described herein may be comprised of one or more conventional processors and unique stored program instructions that control the one or more processors to implement, in conjunction with certain non-processor circuits, some, most, or all of the functions of receiving a side call request at a user interface of a conferencing system terminal device and, in response, presenting a prompt allowing a selection of a subset of the plurality of remote electronic devices for inclusion in a side call during a videoconference as described herein. The non-processor circuits may include, but are not limited to, a radio receiver, a radio transmitter, signal drivers, clock circuits, power source circuits, and user input devices.

As such, these functions may be interpreted as steps of a method to perform the establishment of a side call during a videoconference without disconnecting the conferencing system terminal device from the videoconference. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ASICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions.

As used herein, components may be “operatively coupled” when information can be sent between such components, even though there may be one or more intermediate or intervening components between, or along the connection path. The terms “substantially,” “essentially,” “approximately,” “about,” or any other version thereof, are defined as being close to as understood by one of ordinary skill in the art, and in one non-limiting embodiment the term is defined to be within ten percent, in another embodiment within five percent, in another embodiment within one percent and in another embodiment within one-half percent. The term “coupled” as used herein is defined as connected, although not necessarily directly and not necessarily mechanically.

As used herein, “side call,” “side conference,” and similar side communications refer to conversations, occurring during a videoconference, where at least the audio, and in most cases the video as well, of each person engaged in the side call or side conference is shared with the other persons of the side call or side conference. As used herein, “side call,” “side conference,” and similar side communications are distinct from text-based communications that occur only via the written word. Also, reference designators shown herein in parenthesis indicate components shown in a figure other than the one in discussion. For example, talking about a device (10) while discussing figure A would refer to an element, 10, shown in figure other than figure A.

Embodiments of the disclosure provide methods and systems for establishing a side call during a videoconference. Embodiments of the disclosure contemplate that in many formal and informal videoconference settings, a participant may want to initiate private conversations with a subset of the attendees of the videoconference. Illustrating by example, when employees of two different companies are engaged in a videoconference, the employees of one company may want to caucus with their coworkers without the employees of the other company listening in on that conversation. They may want to caucus to, for example, see if they have an internal consensus on a particular topic before presenting that topic to the other company.

Similarly, in educational settings a set of close friends may want to have a side conversation to discuss how to get a better understanding on what is being taught. While such sidebars and caucus conversations are naturally possible in physically attended, face to face meetings, they are not possible using prior art videoconference systems.

Advantageously, embodiments of the disclosure provide a solution to this problem. In one or more embodiments a method in a conferencing system terminal device comprises detecting, with one or more processors during a videoconference, a communication device electronically in communication with a plurality of remote electronic devices engaged in the videoconference. In one or more embodiments, a user interface operable with the one or more processors receives user input initiating a communication operation at the conferencing system terminal device. In one or more embodiments, in response to the user input, one or more processors of the conferencing system terminal device present a prompt allowing a selection of a subset of the plurality of remote electronic devices for a side call during a videoconference.

Consider how beneficial embodiments of the disclosure can be from the following example: Assume Amit is in a videoconference with several associates, all of whom work for Henry Company. These associates are videoconferencing with employees from Block Company, who is a third-party vendor to Henry Company.

During the videoconference, Amit realizes that he may have to make a request in a few minutes time to Block Company. However, he is unclear on a few details concerning the request. He pings a colleague, Jinendra, to obtain said details. However, Jinendra misses the ping as he is too deeply engrossed in the videoconference. Jinendra ultimately may respond but, alas, it likely will be too late.

If this had been a face-to-face meeting, rather than a videoconference, Amit could have had a quick private caucus with Jinendra so as to be better briefed regarding the details of the request. However, using prior art videoconferencing systems, this is not possible. While many videoconferencing systems offer text-based chat windows, these text-based communications are inefficient and cumbersome. Indeed, Amit may spend more time typing and waiting for responses that it would have taken to have the entire detail-refreshing discussion with Jinendra. Moreover, in addition to taking more time to create, text messages in chat windows take longer to understand and assimilate and serve as a distraction from the overall videoconference.

Consider another example: Vignesh is engaged in a videoconference with his management at work as well as the entire team that reports to him. One of his team members in the call, Nitin, is scheduled to speak next in the videoconference. Vignesh suddenly remembers an important point that he needs to add to Nitin's presentation. As Vignesh is still engaged in the videoconference, he turns OFF his video feed, mutes his microphone, picks up a phone, and calls Nitin.

Nitin, still scheduled to speak next, is confused as to why he is receiving a call.

Nonetheless, he answers anyway. Vignesh starts discussing the point with Nitin, but the Vice President of the company asks Vignesh a question. So as not to disappoint the Vice President, Vignesh hangs up with Nitin, unmutes himself, and answers.

After doing so, Vignesh frantically calls Nitin again. However, in the process he forgets to mute his microphone. Everyone engaged in the videoconference hears their conversation until Vignesh, embarrassed, finally mutes his microphone.

To avoid such embarrassing scenarios, embodiments of the disclosure advantageously provide a conferencing system terminal device where one or more processors are configured to detect receipt of a side call request at a user interface, and in response to the side call request, present a prompt allowing a selection of a subset of the plurality of remote electronic devices for inclusion in a side call during a videoconference. Said differently, amidst an ongoing videoconference, embodiments of the disclosure enable a first participant to have private audio, and typically video as well, conversations with selected participants in such a manner that the audio from the first participant reaches only select participants engaged in the side call.

Accordingly, when a first participant is engaged in a videoconference with several people and the first participant wants to have a private side call with a subset of the participants, in one or more embodiments the first participant delivers user input to a user interface of the conferencing system terminal device and receives a prompt allowing a selection of a subset of participants by allowing a selection of a subset of the plurality of remote electronic devices engaged in the videoconference to participate in the side call.

At the side call initiator's side, in one or more embodiments when a participant tries to unmute their microphone, a prompt appears providing the side call initiator the option to unmute the microphone for all participants or unmute for only selected participants. Since the side call initiator desires to engage in a side conference, in one or more embodiments he selects the option to unmute selected participants. He is then presented with a list of participants engaged in the videoconference with the option to enable a selection of a subset to invite to the side call. Assuming N participants in the videoconference, this subset selection allows a selection of up to N−2 participants in one or more embodiments.

The conferencing system terminal devices of the selected participants then receive a side call invitation. When this occurs, the mainstream videoconference is not disconnected. Assuming the selected participants accept the side call invitation, their respective conferencing system terminal devices transmit a side call acceptance communication to the side call initiator's conferencing system terminal device. Thereafter, communication devices of each conferencing system terminal device establish the side call during the videoconference without disconnecting the respective conferencing system terminal devices from the videoconference.

In one or more embodiments, when the side call is established, the volume of the mainstream videoconference is lowered. The microphones of the side call participants are only unmuted for the other side call participants. For the videoconference participants not engaged in the side call, microphones of the side call participants remain muted. Thus, the side call participants are able to have a private side conference without the remaining participants of the videoconference hearing the same. In one or more embodiments, the volume of the side call is kept at a higher level than that of the videoconference so that the participants can hear the side call.

From the receiving party's side, they are presented with a side call invitation allowing the recipient to accept or reject the side call invitation. Presuming the recipient accepts the side call invitation, the mainstream videoconference is not disconnected but its volume is reduced to a comfortable level so as to prevent distraction.

As the various side call participants leave the side call, or alternatively when the side call initiator terminates the side call, the mainstream videoconference is restored. The microphones are muted to all in one or more embodiments. The volume of the mainstream videoconference is restored to its original level at the conferencing system terminal devices of the side call participants. In one or more embodiments, the audio communicated during the side call is not including in any recordings or transcripts of the videoconference.

Additional options can be added to the side call system. Illustrating by example, a side call user interface can highlight videoconference participants associated with a particular organization, such as a company, school, or club. This provides a shortcut for side call initiators to select their fellow colleagues without selecting people from other organizations.

In other embodiments, videoconference participants who are superiors of a side call initiator, or alternatively report to a side call initiator, can be highlighted to allow a side call initiator to select everyone other than their superior. The prompt initiating the side call can include a radio button that allows the video feed to participants of the videoconference not engaged in the side call to be turned OFF in one or more embodiments. In cases where such side calls are allowed and become mainstream, the side call user interface can automatically provide a status notification to the participants not engaged in the side call, examples of which include “user is in a private conversation,” or “be right back,” and so forth. When the side call terminates, an updated status notification can be provided indicating that the side call participants have again turned their attention to the videoconference. Other advantages will be described below. Still others will be obvious to those of ordinary skill in the art having the benefit of this disclosure.

In one or more embodiments, a conferencing system terminal device comprises a communication device in communication with a plurality of remote electronic devices during a videoconference. The conferencing system terminal device includes a user interface and one or more processors operable with the user interface and the communication device.

In one or more embodiments, the one or more processors detect receipt of a side call request at a user interface and, in response to the side call request, present a prompt allowing a selection of a subset of the plurality of remote electronic devices for inclusion in a side call during the videoconference. On the recipient's side, a method in a conferencing system terminal device includes receiving, by a communication device from a remote electronic device engaged in the videoconference while the conferencing system terminal device is engaged in the videoconference, a side call invitation. The communication device can then transmit a side call acceptance to the remote electronic device and can establish a side call with the remote electronic device during the videoconference and without disconnecting the conferencing system terminal device from the videoconference.

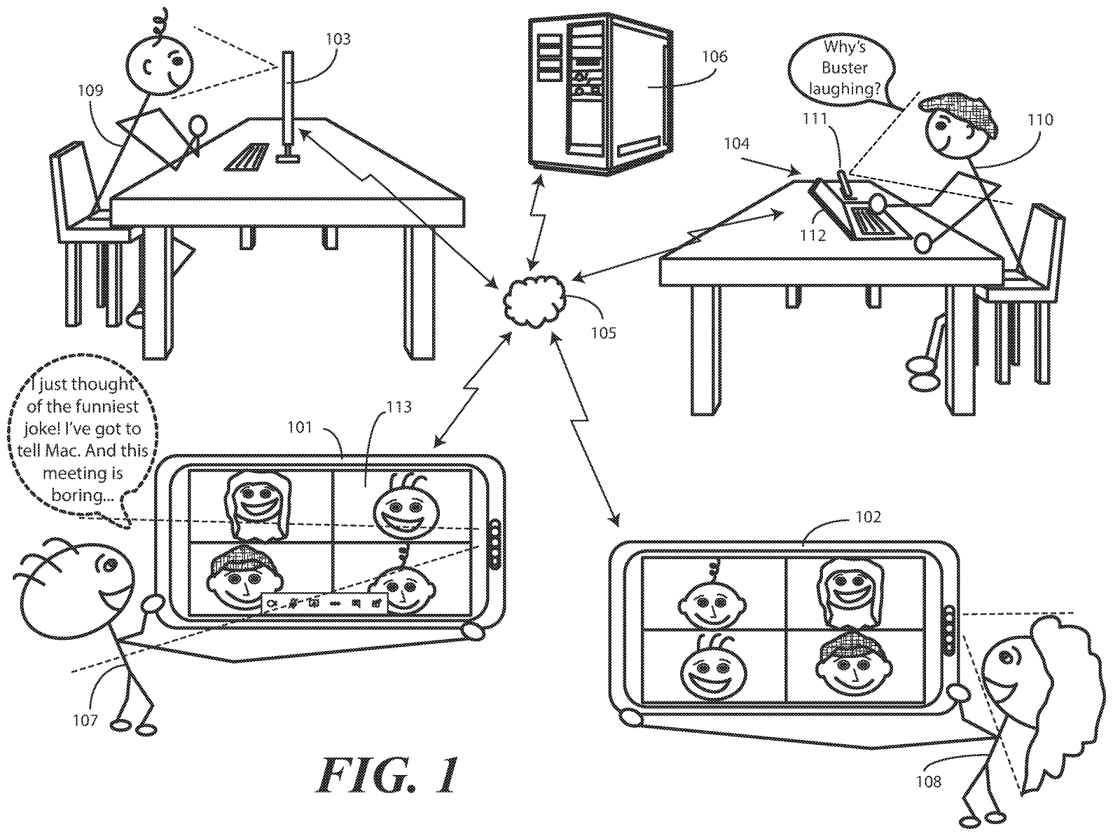

Turning now to FIG. 1, illustrated therein is one explanatory videoconference system in accordance with one or more embodiments of the disclosure. As shown, multiple participants 107,108,109,110 each employ their own respective conferencing system terminal device 101,102,103,104 to engage with the other participants via the videoconference. In this illustrative embodiment, conferencing system terminal devices 101,102 are shown as smartphones, while conferencing system terminal device 103 is a desktop computer. Conferencing system terminal device 104 is a hybrid system where participant 110 watches the other participants 107,108,109 on a laptop computer 112 but uses the superior camera of his smartphone 111 to capture images of his face.

However, conferencing system terminal devices suitable for use in the videoconference system can take other forms as well. For instance, tablet computers, notebook computers, audiovisual devices, mobile phones, smart watches, or other devices can be used by participants to engage in the videoconference as well. Other examples of conferencing system terminal devices will be obvious to those of ordinary skill in the art having the benefit of this disclosure.

As shown in FIG. 1, each conferencing system terminal device 101,102, 103, 104 is engaged in wired or wireless communication with each other across a network 105, one example of which is the Internet via the World Wide Web. It should be noted that the network 105 could be a public, private, local area, wide area, or other type of network across which wired or wireless electronic communications can be exchanged.

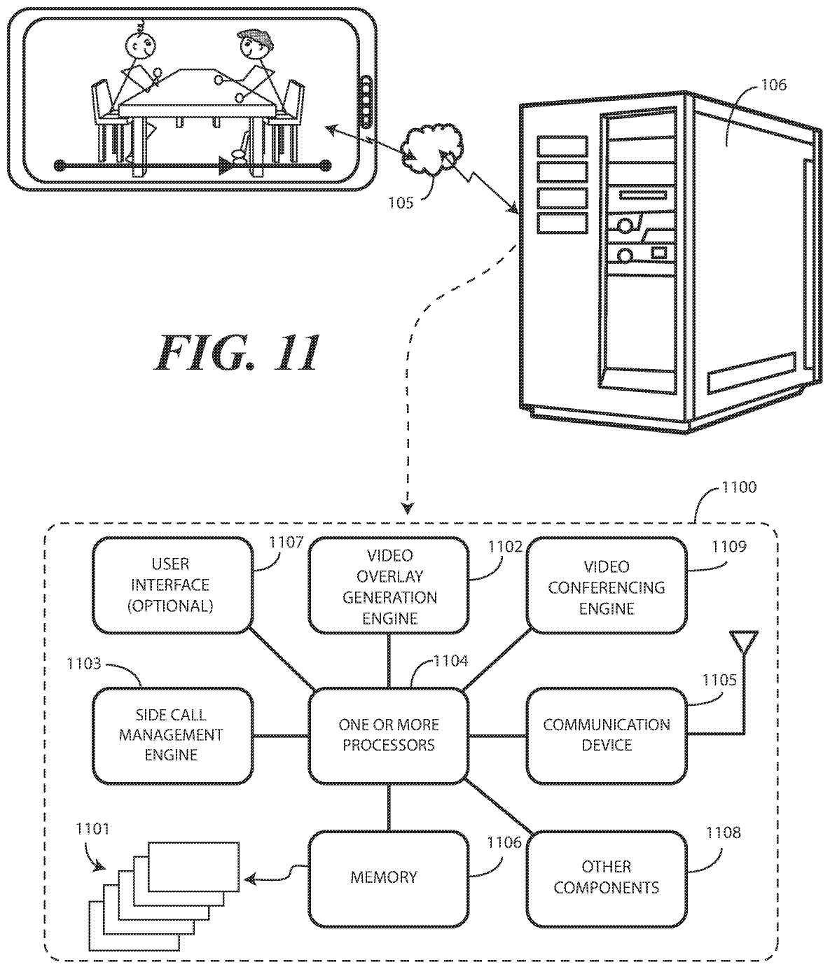

In this illustrative embodiment, each conferencing system terminal device 101,102,103,104 is also in communication with a video conferencing system server complex 106 across the network 105. As will be described in more detail with reference to FIG. 11 below, in one or more embodiments video conferencing system server complex 106 includes components such as a web server, a database server, an audio server, and optionally a video server (the video server may be omitted for audio only conferencing systems) that are operable to facilitate videoconferences between the various conferencing system terminal devices 101,102, 103,104 of the videoconference system.

These components of the video conferencing system server complex 106 can be combined on the same server. Alternatively, these components can be distributed on any number of servers to increase load handling capacity beyond that of a single server, and so forth. Other configurations for the video conferencing system server complex 106 will be obvious to those of ordinary skill in the art having the benefit of this disclosure.

In one or more embodiments, the video conferencing system server complex 106 performs functions such as maintaining a schedule of videoconferences, maintaining lists of participants, as well as allowing each participant's conferencing system terminal device to engage with the videoconference, and so forth. In one or more embodiments, the video conferencing system server complex 106 also facilitates the transmission of audio and video content during the occurrence of the videoconference.

In one or more embodiments, the video conferencing system server complex 106 functions as an intermediary device to facilitate sharing of audio and/or video content and/or data between the various conferencing system terminal devices 101,102, 103,104. For example, as can be seen on the displays of conferencing system terminal devices 101,102, in this example each participant 107,108, 109, 110 can see each other participant engaged in the videoconference.

In the illustrative example of FIG. 1, the participants 107,108,109, 110 are engaged in the videoconference. Since the participants 107,108,109,110 are all engaged in a videoconference, each can see conference content in the form of a combined video feed from each other participant 107,108,109,110 presented on the display of each conferencing system terminal device 101,102,103,104, as well as a video feed of themselves. Each participant 107,108, 109,110 can hear an audio feed from each other participant 107,108,109,110 as well.

In this illustrative example, Buster, who is participant 107, has just thought of the funniest joke. As shown in his dashed line thought bubble, he desperately wants to share the joke with Mac, who is participant 110. Indeed, Mac, who can see Buster's face but (of course) cannot hear his thoughts, asks, “Why is Buster laughing?” After all, this is supposed to be a serious meeting, not open mic night at the local comedy club.

While Buster really wants to share the joke with Mac, this is indeed a serious meeting. Accordingly, Buster knows that participant 108 and participant 109 may not appreciate the humor, scolding Buster for this being neither the “right place” nor the “right time” for comedy. However, Buster and Mac are the dearest and oldest of friends, and Buster is convinced that Mac will see the genius of the joke's form. Buster just knows that sharing the joke with Mac will brighten each other's day and make the videoconference a more enjoyable affair.

With prior art videoconference systems, there is no real way for Buster to share the joke with Mac. If Buster wants to tell the joke to Mac, Piper, who is participant 108, and Henry, who is participant 109, will both be able to hear the joke. This is true because prior art systems do not offer a mechanism for Mac to speak only to Buster. While some prior art systems do allow participants to communicate directly by text using a chat feature, this option is unsatisfactory to Buster too. Since the videoconference is being recorded, all text typed into the chat box is also being recorded. Since Henry is the presenter, he would then be able to review the footage to see the joke.

Advantageously, embodiments of the disclosure provide a solution to this problem. In one or more embodiments a method in a conferencing system terminal device comprises detecting, with one or more processors during a videoconference, a communication device electronically in communication with a plurality of remote electronic devices engaged in the videoconference. In one or more embodiments, a user interface operable with the one or more processors receives user input initiating a communication operation at the conferencing system terminal device. In one or more embodiments, in response to the user input, one or more processors of the conferencing system terminal device present a prompt allowing a selection of a subset of the plurality of remote electronic devices for a side call during a videoconference.

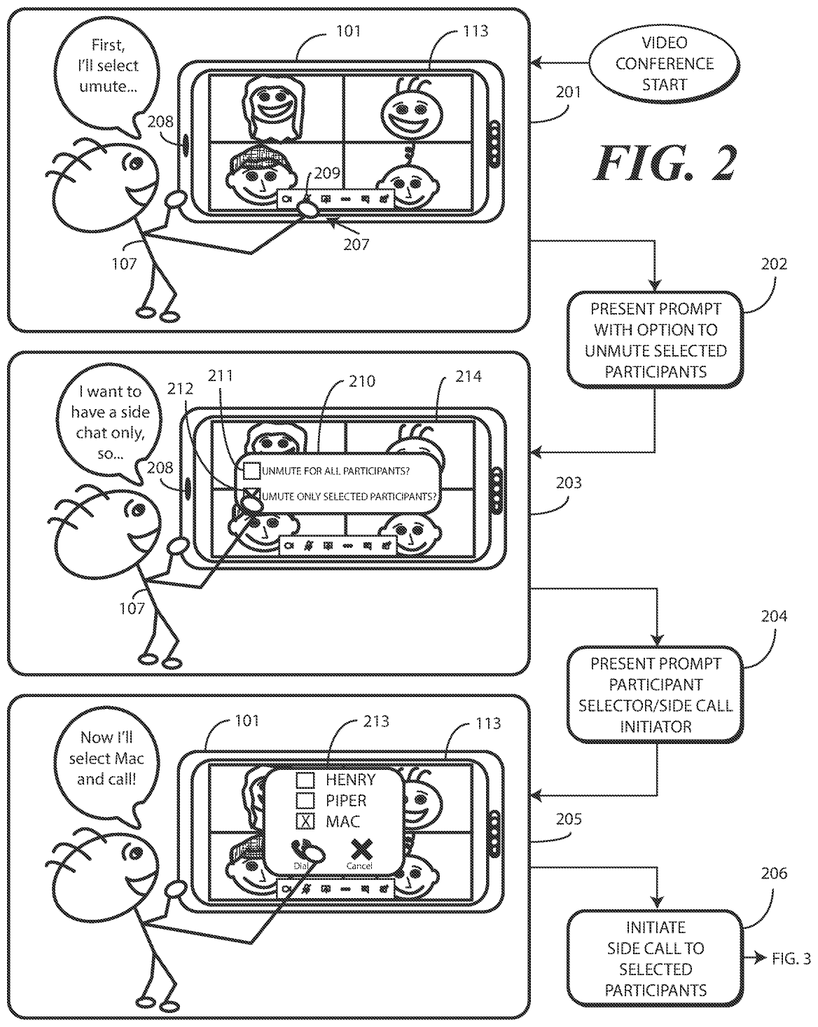

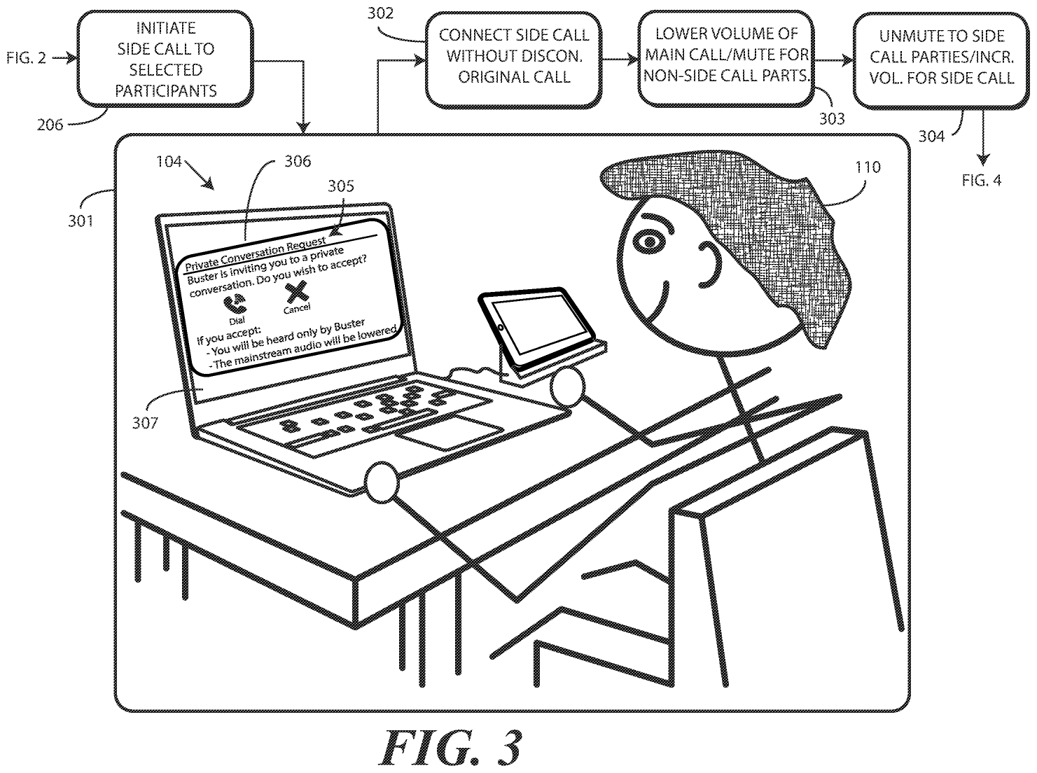

Applying these steps to the illustrative example of FIG. 1, one or more processors of Buster's conferencing system terminal device 101 can detect, during the videoconference, a communication device of the conferencing system terminal device 101 electronically in communication with a plurality of remote electronic devices engaged in the videoconference, which in this example are conferencing system terminal devices 102,103,104. A user interface, e.g., the touch-sensitive display 113 of conferencing system terminal device 101, which is operable with the one or more processors of conferencing system terminal device 101, can receive user input from participant 108 initiating a communication operation at the conferencing system terminal device 101. In one or more embodiments, in response to the user input, one or more processors of the conferencing system terminal device present 101 a prompt allowing a selection of a subset of the plurality of remote electronic devices for a side call during a videoconference. These method steps are shown in FIG. 2.

Turning now to FIG. 2, as shown the videoconference of FIG. 1 has already started. Consequently, one or more processors of conferencing system terminal device 101 detect a communication device of conferencing system terminal device 101 in communication with a plurality of remote electronic devices engaged in the videoconference. These remote electronic devices were represented by conferencing system terminal devices (102,103,104) in FIG. 1.

At step 201 the user interface of conferencing system terminal device 101, here touch-sensitive display 113, receives user input 207 initiating a communication operation at the conferencing system terminal device 101. In this illustrative embodiment, the user input 207 initiating the communication operation comprises a request for a microphone 208 of the conferencing system terminal device 101 to be unmuted, as indicated by the fact that participant 107 is touching the microphone user actuation target 209 with the slash through the microphone to request that the microphone 208 of the conferencing system terminal device 101 be unmuted. At step 202, one or more processors of the conferencing system terminal device 101 present, at the user interface, a prompt allowing a selection of a subset of the plurality of remote electronic devices for a side call during the videoconference. This prompt 210 is shown at step 203.

In this illustrative embodiment, the prompt 210 initially allows for a selection 211 of unmuting the microphone 208 of conferencing system terminal device 101 for all participants and another selection 212 for unmuting the microphone 208 of the conferencing system terminal device 101 for only selected participants. Here, participant 107 selects the latter. In one or more embodiments, the prompt 210 facilitates temporary suspension of the videoconference in an application portal 214 facilitating the videoconference being presented at the user interface of the conferencing system terminal device 101 while the side call is occurring by allowing the selection of the subset of the plurality of remote electronic devices with which the side call will be established.

At step 204, in response to the user input received at step 201 and step 203, the one or more processors of the conferencing system terminal device 101 present another prompt configured to receive other user input selecting the subset of the plurality of remote electronic devices so that the side call with these subset of the plurality of remote electronic devices can be established without disconnecting conferencing system terminal device 101 (or the other conferencing system terminal devices engaged in the side call) from the main videoconference. Said differently, at step 204 a prompt is presented so that participant 107 can select which people should be invited to the side call. The one or more processors of conferencing system terminal device 101 identify the people by identifying their corresponding conferencing system terminal device, thereafter presenting the names of the participants (rather than device identifiers) in the prompt in this illustrative embodiment. One example of such a prompt 213 is shown at step 205.

In this illustrative embodiment, the prompt 213 lists the other participants of the call, namely, Henry, Piper, and Mac, and allows Buster to select which participants should be involved in the side call. As shown, Buster has selected Mac by delivering touch input to the touch-sensitive display 113 of the conferencing system terminal device 101. Buster then delivers additional touch input to the touch-sensitive display 113 of conferencing system terminal device 101 at the prompt 213 to initiate the side call.

While presenting the “top level” selection of whether to select all participants or only selected participants at step 203, with a second “sub level” selection of which participants should be included in the subset at step 205 is one way to facilitate establishing a side call during a videoconference, with in other embodiments a more direct route can be taken. Illustrating by example, the prompt 210 of step 203 may have listed the participants initially, rather than requesting a top-level selection of unmuting for all—or only some—as was the case in this illustrative embodiment.

Additionally, in one or more embodiments where the participants are presented in a prompt, shortcuts can be enabled to allow for the selection of a group to be included in the subset of the plurality of remote electronic devices rather than selecting the people, and therefore their corresponding remote electronic devices, individually. Illustrating by example, in one or more embodiments the prompt 210 presented at step 203 or the prompt 213 presented at step 205 can identify one or more processors participants (which identifies one or more remote electronic devices) owned by owners belonging to a single organization. If Buster and Mac both worked for Block Company, this would allow for a quick selection of Mac without having to navigate to his name individually for selection.

Similarly, in one or more embodiments the prompt 210 presented at step 203 or the prompt 213 presented at step 205 can identify one or more remote electronic devices owned by employment superiors of an authorized user of the conferencing system terminal device 101, which in this case is Buster. If Henry is Buster's boss at work, such a short cut makes it easy for Buster to ensure that his boss does not hear the joke when the side call is initiated at step 206.

In other embodiments, the prompt 210 presented at step 203 or the prompt 213 presented at step 205 can identify a plurality of remote electronic devices owned by employment subordinates of the authorized user of the conferencing system terminal device 101. If, for example, Piper works for Buster, such a shortcut would allow Buster to ensure that conversations intended to be among only workers of a same pay grade, which may include Buster's joke, are not shared with subordinates. Other examples of shortcuts will be described below. Still others will be obvious to those of ordinary skill in the art having the benefit of this disclosure.

The side call is then initiated at step 206. Once the side call is initiated, a variety of operations, each of which can be used alone or in combination, can occur. Some of these operations are shown in FIG. 3. Others will be obvious to those of ordinary skill in the art having the benefit of this disclosure.

Turning now to FIG. 3, step 206 first initiates the side call. When this occurs, as shown at step 301, conferencing system terminal device 104 receives, by a communication device from a remote electronic device engaged in a videoconference, here conferencing system terminal device (101), while conferencing system terminal device 104 is engaged in the videoconference, a side call invitation 305. The one or more processors of the conferencing system terminal device 104 then present a prompt 306 corresponding to the side call invitation 305 on a user interface 307 of conferencing system terminal device 104.

As shown at step 301, the prompt 306 allows participant 110 to accept the side call invitation 305 or reject the side call invitation 305. In this illustrative embodiment, the prompt 306 also presents additional information and details associated with the side call invitation 305. For instance, in this example the prompt 306 identifies which other participant (107) is inviting participant 110 to the side call. Additionally, the prompt 306 presents conditions and constructs that will be employed during the side call. Examples of such conditions and constructs include the fact that Mac will only be heard by Buster.

In one or more embodiments, when the side call commences, an output volume of the videoconference from an audio output of conferencing system terminal device 104 will be reduced while the side call is occurring. This fact is another example of such a condition and construct presented in the prompt 306 as shown at step 301. These two conditions and constructs are illustrative only, as numerous others will be obvious to those of ordinary skill in the art having the benefit of this disclosure.

In this illustrative embodiment, the prompt 306 also includes user actuation targets that participant 110 can select to either accept or the side call invitation 305. Since Mac is dying to hear what Buster thinks is so funny, he delivers user input to conferencing system terminal device 104 to accept the side call invitation.

At step 302, the communication device of conferencing system terminal device 104 transmits a side call acceptance communication to conferencing system terminal device (101). Step 302 then comprises the communication device of conferencing system terminal device 104 establishing the side call without disconnecting the conferencing system terminal device 104 from the main videoconference with conferencing system terminal devices (102, 103).

As noted above, once this occurs, one or more optional steps can be performed alone or in combination. Illustrating by example, at step 303 one or more processors of conferencing system terminal device 104 reduce the output volume of the main videoconference from an audio output device of the conferencing system terminal device 101 while the side call is occurring. In one or more embodiments, step 303 also comprises precluding the communication device from transmitting audio signals to the remote electronic devices not engaged in the side call. Thus, when participant 110 speaks, only participant (107) will be able to hear his voice. Participants (108,109) will not be able to hear their side conversation.

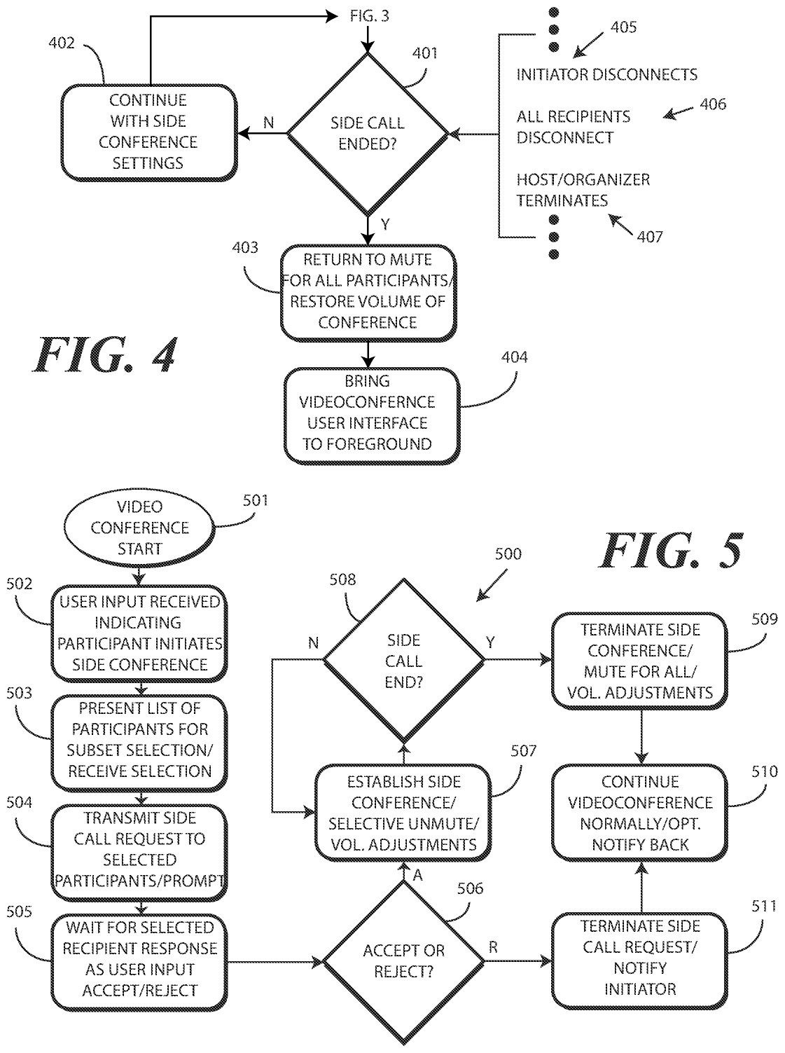

Meanwhile, step 304 allows the communication device of conferencing system terminal device 104 to transmit audio signals from the conferencing system terminal device 104 to the conferencing system terminal device (101) initiating the side call. The same happens in reverse, thereby allowing Buster to tell the joke to Mac and Mac to respond to the same. In this case, Buster says, during the side call, “two peanuts were walking down the road . . . and one was assaulted . . . peanut,” to which Mac almost falls out of his chair with hilarious laughter. The method steps begun in FIG. 2, and then continued in FIG. 3, then move to FIG. 4.

Turning now to FIG. 4, decision 401 determines whether the side call has ended. This can be done in a variety of ways. Illustrating by example, the initiator may disconnect 405 from the side call. In one or more embodiments, since the initiator of the side call is presumed to be the presenter of the side call, when the initiator disconnects 405, the side call ends.

In another embodiment, the side call can end when all participants disconnect 406. If there are three or more participants in a side call, for example, and the initiator disconnects, embodiments of the disclosure contemplate that the others may want to remain in the side call. Accordingly, in some embodiments the side call will not end until all participants disconnect 406.

In still other embodiments, a host or organizer may want to terminate 407 side calls so that more thoughtful attention is paid to the main videoconference. Thus, in one or more embodiments while the host or presenter of a videoconference may not be able to hear the audio of a side call, they may he apprised to the fact that a side call is occurring. As such, if the host or organizer terminates 407 the side call, decision 401 will determine that the side call has ended as well.

While the side call continues, step 402 continues with the side call settings. This can include the lowered volume of the main videoconference set when the side call is established, as well as the fact that the microphones of the side call participants are only unmuted for the other side call participants. For the videoconference participants not engaged in the side call, microphones of the side call participants remain muted. Thus, at step 402 the side call participants can have a private side conference without the remaining participants of the videoconference hearing the same. In one or more embodiments, the volume of the side call is kept at a higher level than that of the videoconference at step 402 so that the participants can hear the side call.

At step 403, once decision 401 indicates that the side call has been terminated, the settings of the mainstream videoconference are restored for the conferencing system terminal devices previously engaged in the videoconference. In one or more embodiments, step 403 comprises restoring the volume of the main videoconference to its original level at the conferencing system terminal devices of the side call participants. In one or more embodiments, the microphones of each conferencing system terminal device previously engaged in the side call are again returned to mute. Thus, in one or more embodiments step 403 comprises increasing the output volume of the main videoconference from the audio output device of each conferencing system terminal device previously engaged in the side call and again muting the microphones of those conferencing system terminal devices.

Embodiments of the disclosure contemplate that when a side call is occurring, a new window or separate side call user interface may be presented allowing the side call participants to each see each other without being distracted by the videoconference participants not participating in the side call. One example of this is shown below with reference to FIG. 9. Where this, or other user interface changes are made, step 404 comprises bringing the videoconference user interface back to the foreground so is operates as the foreground application.

Turning now to FIG. 5, illustrated therein is one explanatory method 500 configured in accordance with one or more embodiments of the disclosure. Beginning at stage 501, a videoconference is initiated. During the videoconference, a plurality of conferencing system terminal devices each employ a communication device to communicate with the other conferencing system terminal devices, which constitute remote electronic devices during the videoconference. In one or more embodiments, each conferencing system terminal device engaged in the videoconference thus has a communication device in communication with a plurality of remote electronic devices during the videoconference. In one or more embodiments, each conferencing system terminal device also includes a user interface and one or more processors operable with the communication device and the user interface.

At step 502, the one or more processors of a conferencing system terminal device detect receipt of a side call request at the user interface. At step 503, the one or more processors present, in response to the side call request, a prompt allowing a selection of a subset of the plurality of remote electronic devices engaged in the videoconference for inclusion in a side call during the videoconference. As noted above, while the communication device is in communication with the other conferencing system terminal devices, and thus identifies remote electronic devices and not people, the prompt may instead present the people associated with each remote electronic device to make the selection of side call participants simpler and more intuitive.

The prompt presented at step 503 can include one or more shortcuts allowing the selection of the subset of the plurality of remote electronic devices easier for the side call initiator. Said differently, in one or more embodiments the prompt presented at step 503 facilitates as shortcut operation to select the subset of the plurality of remote electronic devices for the side call during the videoconference.

Illustrating by example, in one or more embodiments the prompt identifies one or more remote electronic device of the plurality of remote electronic devices owned by owners belonging to a single organization. In other embodiments, the prompt identifies one or more remote electronic devices of the plurality of remote electronic devices owned by employment superiors of an authorized user of the conferencing system terminal device initiating the side call. In similar fashion, the prompt may identify one or more remote electronic devices of the plurality of remote electronic devices owned by employment subordinates of the authorized user of the conferencing system terminal device initiating the side call. A selection of the remote electronic devices that are to be included in a side call invitation is received at step 503.

At step 504, the one or more processors of the conferencing system terminal device receiving the side call request at step 502 then transmit a side call invitation to the subset of the plurality of remote electronic devices inviting them to the side call. At step 505, the one or more processors await to receive a response communication. In one or more embodiments, the response communication is either a side call acceptance communication or a side call reject communication. Which is received is determined at decision 506.

When decision 506 determines that at least one side call acceptance is received, at step 507 the one or more processors of the conferencing system terminal device establish the side call during the videoconference. In one or more embodiments, this establishment of the side call occurs without disconnecting the conferencing system terminal device from the main videoconference. In effect, two parallel videoconferences are being conducted by the same conferencing system terminal device. The first is the main videoconference, which may have its volume lowered during the side call, and the second is the side call, which may have its volume increased so that the side call participants can each hear each other.

In one or more embodiments, if decision 506 determines that a side call reject communication is received indicating that a side call invitee does not wish to participate in a side call, the one or more processors terminate the side call request at step 511 and optionally notify the side call initiator that the side call invitee is not interested in a side call at this time. All normal settings to the main videoconference can then be returned at step 510.

Where the side call is established at step 507, a number of optional steps can occur as well. These optional steps include allowing the communication device of the conferencing system terminal devices engaged in the side call to transmit audio signals from the conferencing system terminal devices only to the subset of the plurality of remote electronic devices engaged in the side call at step 507. Similarly, step 507 can comprise precluding the communication device of the conferencing system terminal devices engaged in the side call from transmitting the audio signals to remote electronic device of the plurality of remote electronic devices omitted from inclusion of the subset of the plurality of remote electronic devices included in the side call. Step 507 can also comprise reducing an output volume of the main videoconference from an audio output device of the conferencing system terminal device while the side call is occurring. In some embodiments, step 507 can comprise delivering, with a communication device engaged in the side call, a notification to the remote electronic device of the plurality of remote electronic devices omitted from inclusion in the subset of the plurality of remote electronic devices engaged in the side call indicating that each conferencing system terminal device included in the subset of the plurality of remote electronic devices engaged in the side call is so engaged while the videoconference is occurring.

In still other embodiments, step 507 can preclude the side call from being recorded along with recordings of the main videoconference. It should be noted that these optional steps are illustrative only, as others will be obvious to those of ordinary skill in the art having the benefit of this disclosure. Moreover, these optional steps can be used alone or in combination.

Decision 508 then determines whether the side call ends. Where it does, step 509 comprises can include muting the microphones of conferencing system terminal devices previously engaged in the side call, thereby precluding the communication device of each such conferencing system terminal device from transmitting audio to the plurality of remote electronic devices engaged in the main videoconference until an unmute request is received at the user interface of one of the conferencing system terminal devices. Step 510 can then increase the output volume of the videoconference from the audio output device of the conferencing system terminal device. Where step 507 provided a status notification to the participants not engaged in the side call, examples of which include “user is in a private conversation,” or “be right back,” and so forth, when the side call terminates step 510 can comprise delivering an updated status notification indicating that the side call participants have again turned their attention to the videoconference.

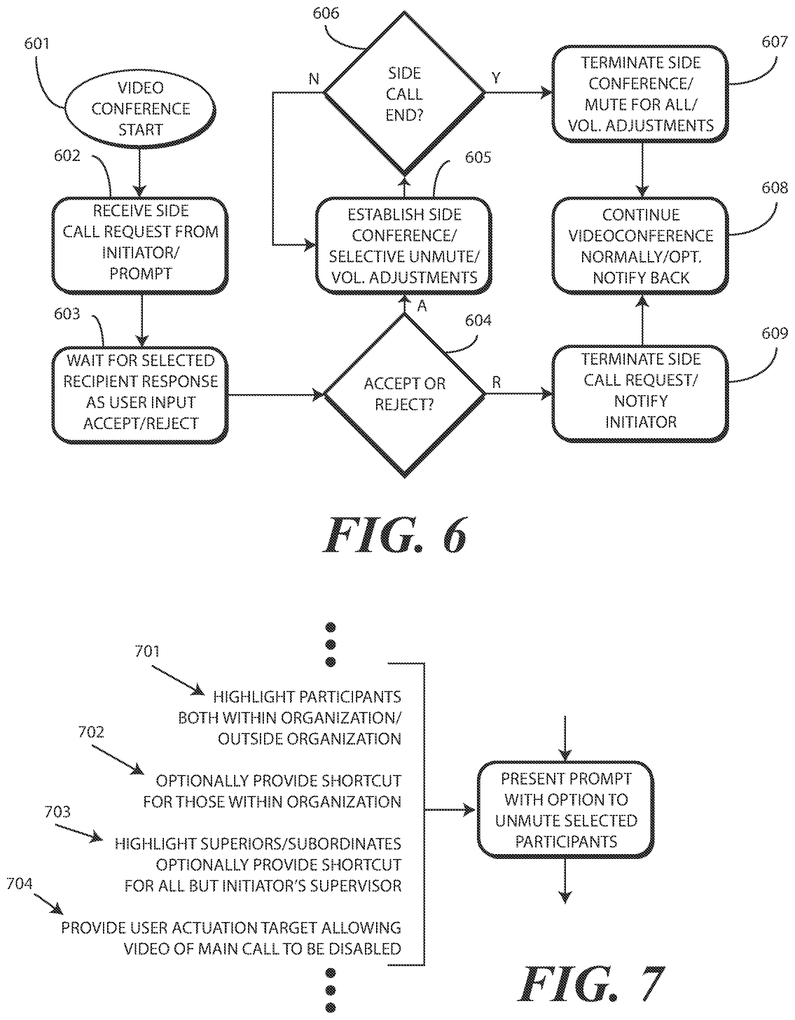

Turning now to FIG. 6, illustrated therein is another explanatory method 600 in accordance with one or more embodiments of the disclosure. The method 600 of FIG. 6 illustrates operations that can occur in a conferencing system terminal device receiving a side call invitation while the conferencing system terminal device is engaged in a videoconference.

Beginning at stage 601, a videoconference is initiated. During the videoconference, a plurality of conferencing system terminal devices each employ a communication device to communicate with the other conferencing system terminal devices, which constitute remote electronic devices during the videoconference. In one or more embodiments, each conferencing system terminal device engaged in the videoconference thus has a communication device in communication with a plurality of remote electronic devices during the videoconference. In one or more embodiments, each conferencing system terminal device also includes a user interface and one or more processors operable with the communication device and the user interface.

At step 602, a communication device of a conferencing system terminal device engaged in a videoconference receives, while the conferencing system terminal device is engaged in the videoconference, a side call invitation. At step 602, one or more processors of the communication device present a prompt at a user interface of the conferencing system terminal device asking a participant if they would like to accept, or decline, the side call invitation.

At step 603, the one or more processors of the conferencing system terminal device wait for the participant's response. In one or more embodiments, the response communication is either a side call acceptance communication or a side call reject communication. Which is received is determined at decision 604. If decision 604 determines that the side call invitation is rejected, step 609 comprises terminating the side call request and notifying the side call initiator.

When decision 604 determines that at least one side call acceptance is received, at step 605 the one or more processors of the conferencing system terminal device establish the side call during the videoconference. Step 605 can comprise performing other optional operations as well.

Illustrating by example, in one or more embodiments despite the side call being established at step 605, the mainstream videoconference is not disconnected. When decision 604 determines that the selected participants accept the side call invitation, their respective conferencing system terminal devices transmit a side call acceptance communication to the side call initiator's conferencing system terminal device. Thereafter, communication devices of each conferencing system terminal device establish the side call during the videoconference without disconnecting the respective conferencing system terminal devices from the videoconference at step 605.

In one or more embodiments, when the side call is established, the volume of the mainstream videoconference is lowered at step 605. The microphones of the side call participants are only unmuted for the other side call participants at step 605 in one or more embodiments. For the videoconference participants not engaged in the side call, microphones of the side call participants remain muted. Thus, the side call participants can have a private side conference without the remaining participants of the videoconference hearing the same. In one or more embodiments, the volume of the side call is kept at a higher level than that of the videoconference so that the participants can hear the side call at step 605.

As the various side call participants leave the side call, as determined at decision 606, or alternatively when the side call initiator terminates the side call, the settings of the main videoconference are restored at step 607 and step 608. For instance, step 607 comprises muting microphones are muted to all participants of the videoconference in one or more embodiments. The volume of the mainstream videoconference is restored to its original level at the conferencing system terminal devices of the side call participants as step 607. When the side call terminates, an updated status notification can be provided indicating that the side call participants have again turned their attention to the videoconference at step 608.

As noted above, additional options can be added to the side call system. In one or more embodiments, these additional options can be added when the prompt is presented allowing a selection of a subset of the plurality of remote electronic devices for a side call. For instance, in some embodiments, changes to the prompt (one example of which was presented at step (204) of FIG. 2) can provide shortcuts and make the selection of the subset of the plurality of remote electronic devices to be included in the side call simpler, faster, and more efficient.

Illustrating by example and turning now to FIG. 7, a side call user interface can highlight videoconference participants associated with a particular organization, such as a company, school, or club. Thus, in one or more embodiments when one or more processors present a prompt allowing a selection of a subset of the plurality of remote electronic devices for a side call in a videoconference, the prompt identifies one or more remote electronic devices of the plurality of remote electronic devices owned by owners belonging to a single organization 701. In other embodiments, the prompt can facilitate a shortcut operation 702 to select the subset of the plurality of remote electronic devices for the side call during the videoconference.

In still other embodiments, the prompt can identify one or more remote electronic device of the plurality of remote electronic devices owned by employment subordinates/superiors 703 of an authorized user of a conferencing system terminal device requesting a side call. In some embodiments, the prompt can facilitate a temporary suspension 704 of the videoconference in an application portal facilitating the videoconference and being presented at the user interface of the conferencing system terminal device while the side call is occurring. This suspension can occur when the application portal presents the side call instead of the videoconference. However, in other embodiments the side call and videoconference will be presented simultaneously.

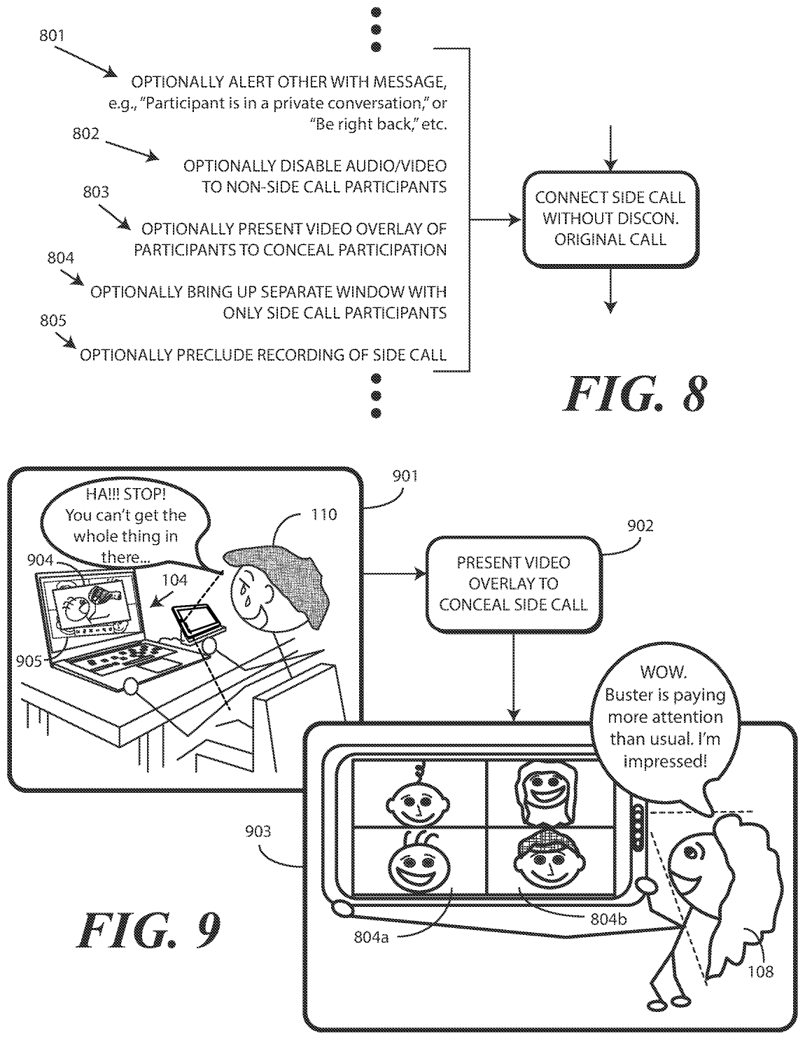

Just as optional operations can be performed when the prompt is presented to streamline operation of embodiments of the disclosure, so too can additional (and optional) features be incorporated into embodiments of the disclosure when the side call is occurring. Turning now to FIG. 8, illustrated therein are some of these additional features. Others will be obvious to those of ordinary skill in the art having the benefit of this disclosure.

In one or more embodiments, when the side call is occurring a notification 801 can be delivered to the remote electronic devices of the plurality of remote electronic devices omitted from inclusion in the subset of the plurality of remote electronic devices. In one or more embodiments, the notification 801 indicates that a particular conferencing system terminal device is engaged in the side call during the videoconference. For instance, the notification 801 might include a status notification to the participants not engaged in the side call. Examples of such status notifications include “user is in a private conversation,” or “be right back,” and so forth. When the side call terminates, an updated status notification can be provided indicating that the side call participants have again turned their attention to the videoconference.

In other embodiments, when the side call is occurring communication devices of conferencing system terminal devices engaged in the side call transmit audio signals from the conferencing system terminal devices to other conferencing system terminal devices engaged in the side call, but preclude 802 the transmission of audio and/or video signals to remote electronic devices of the plurality of remote electronic devices omitted from inclusion in the subset of the plurality of remote electronic devices included in the side call. This allows each participant of the side call to see and hear each other, while concealing the side call from non-side call participants.

In some embodiments, deep concealment of the side call will be desired. Illustrating by example, some side call participants may want their participation in the side call to be covert and concealed from anyone not in the side call. Where this is the case, the one or more processors of each conferencing system terminal device engaged in the side call may cause the corresponding communication device to transmit a video overlay 803 for an authorized user of the conferencing system terminal device to remote electronic devices of the plurality of remote electronic devices omitted from inclusion in the subset of the plurality of remote electronic devices. In one or more embodiments, the video overlay 803 conceals participation of the authorized user in the side call while the side call is occurring.

Turning now briefly to FIG. 9, illustrated therein is how this can occur. At step 901, the shenanigans from FIGS. 2 and 3 above continue. As shown an application portal 904 facilitating the side call has been overlayed atop an application portal 905 facilitating the main videoconference. While the main videoconference continues in the background application portal 905, the volume has been reduced while the volume of the side call, occurring in the foreground application portal is increased. Thus results in a suspension of the main videoconference. Participant 110 can still hear and see the videoconference and can return the background application portal 905 to the foreground at any time. However, participant 110 is more engaged in the side call.

As shown at step 901, after making Mac laugh so hard with the joke about the peanut, Buster keeps rolling, asking Mac, “What did the octogenarian pirate say?” Not hesitating a moment, Buster says, “Ave Mateyyyy . . . ,” which makes Mac totally lose it with laughter. Out of jokes, Buster claims he can stick a whole ham in his mouth. Mac, who is now totally crying with laughter, says, “STOP! You can't get the whole thing in there. . . . ”

Needless to say, if this is an important business meeting, many participants of the main videoconference might frown upon such antics. However, in this case the conferencing system terminal device 104 is configured in accordance with one or more embodiments of the disclosure. Accordingly, at step 902 both conferencing system terminal device (101) and conferencing system terminal device (104) deliver, with a communication device, a video overlay 804a,804b that conceals their participation in the side call.

In this illustrative embodiment, the video overlay 804a,804b comprises a loop of video footage of participant (107) and participant 110 depicting each looking into the eyes of the image capture device of their conferencing system terminal device (101), 104. In other embodiments, the video overlay 804a, 804b comprises computer-generated imagery (CGI), an animation, previously recorded video or images of each participant, or other compensating content overlays to conceal their participation in the side call.

In one or more embodiments, the delivery of the video overlay 804a, 804b occurs automatically when a side call begins. In other embodiments, the delivery of the video overlay 804a, 804b can occur in response to user input requesting the same. Of course, a combination of the two approaches can be used as well. A conferencing system terminal device can deliver the video overlay 804a, 804b not only when requested by a user, but also when specific conditions in a side call are detected, examples of which include excessive laughter, crying, sleeping, shouting, or a discussion using names of people engaged in the videoconference but not engaged in the side call. Illustrating by example, if a participant starts laughing like Mac during a business meeting, the one or more processors can cause the delivery of the video overlay 804a,804b so that others do not have to witness the hilarity.

The delivery of the video overlay 804a,804b can originate locally from a conferencing system terminal device in one or more embodiments. In other embodiments, a conferencing system server complex can cause the delivery of the video overlay 804a, 804b. Illustrating by example, as will be described below with reference to FIG. 11, in one or more embodiments a conferencing system server complex comprises a video conferencing engine delivering video conferencing content to a plurality of conferencing system terminal devices during a videoconference. A side call monitoring engine can monitor for participants engaging in side calls during the videoconference. One or more processors can generate delivery of the video overlay 804a, 804b when one or more of the preconditions described above are met, or when requested by a side call participant. The one or more processors can deliver the video overlay 804a,804b instead of live depictions of the side call participants to conceal their participation in the side call from others in the group.

As shown at step 903, the delivery of the video overlay 804a, 804b causes participant 108 to think both Buster and Mac, but Buster in particular, are really paying close attention to the videoconference. Participant 108 thinks this is unusual, because Buster is generally telling jokes. Accordingly, she makes a note of is better than normal attention.

Turning now back to FIG. 8, in one or more embodiments a separate window 804 that includes only side call participants can be presented when the side call commences. This was the case in FIG. 9 with application portal (904). In some embodiments, the separate window 804 can be presented adjacent to the videoconference so that both the videoconference and the side call can be seen. In other embodiments, the separate window 804 can be presented atop the videoconference so that the separate window 804 becomes the foreground application while the window with the videoconference becomes the background application. In still other embodiments, the separate window 804 can be expanded into an immersive mode such that it facilitates a temporary suspension of the videoconference while the side call is occurring.

In still other embodiments, recording of the side call can be precluded 805. Clearly, Buster and Mac would want this as some videoconference participants may not get that “Aye, Matey” is a homophone for “I'm eighty.” Accordingly, they may not get the humor of the joke and may feel left out. Accordingly, in one or more embodiments the one or more processors of the conferencing system terminal devices engaged in the side call not only allow their communication devices to transmit audio and video signals from the conferencing system terminal device to the subset of the plurality of remote electronic devices while precluding the communication device from transmitting the audio and video signals to remote electronic devices of the plurality of remote electronic devices omitted from inclusion in the subset of the plurality of remote electronic devices, but also preclude 805 the side call during the videoconference from being recorded as well.

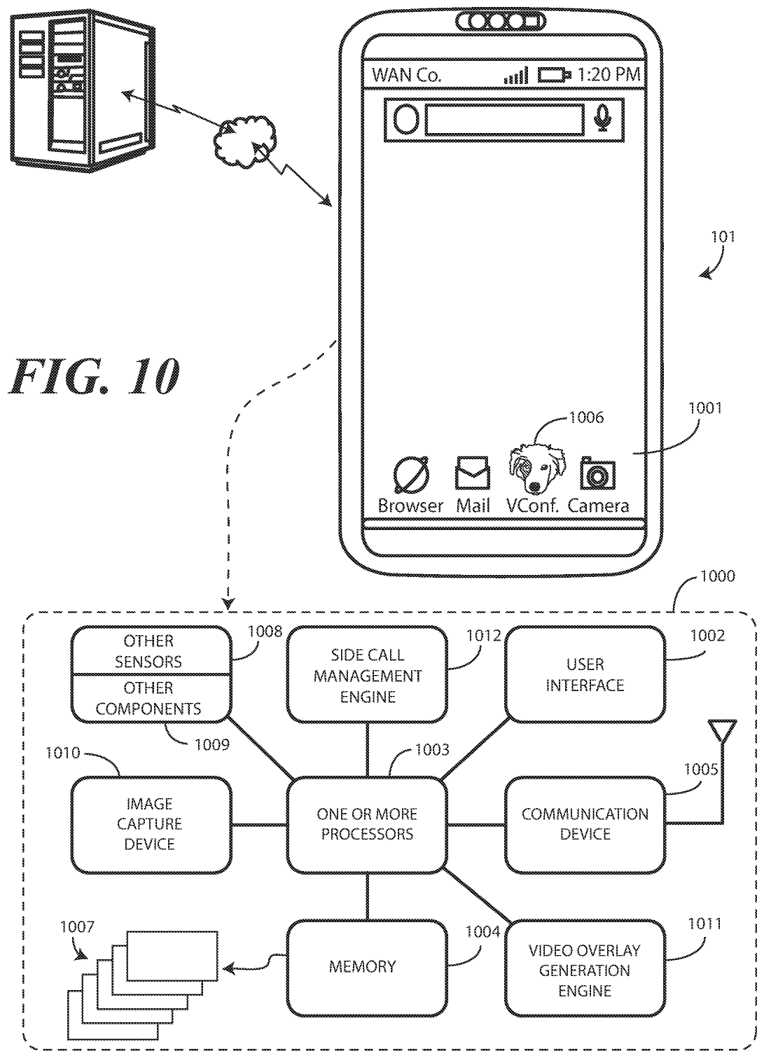

Turning now to FIG. 10, illustrated therein is one explanatory conferencing system terminal device 101. The conferencing system terminal device 101 of FIG. 10 is a portable electronic device. For illustrative purposes, the conferencing system terminal device 101 is shown as a smartphone. However, the conferencing system terminal device 101 could be any number of other devices as well, including tablet computers, desktop computers, notebook computers, and so forth. Still other types of conferencing system terminal devices can be configured in accordance with one or more embodiments of the disclosure as will be readily appreciated by those of ordinary skill in the art having the benefit of this disclosure.

This illustrative conferencing system terminal device 101 includes a display 1001, which may optionally be touch-sensitive. In one embodiment where the display 1001 is touch-sensitive, the display 1001 can serve as a primary user interface 1002 of the conferencing system terminal device 101. Users can deliver user input to the display 1001 of such an embodiment by delivering touch input from a finger, stylus, or other objects disposed proximately with the display 1001.

In one embodiment, the display 1001 is configured as an active-matrix organic light emitting diode (AMOLED) display. However, it should be noted that other types of displays, including liquid crystal displays, would be obvious to those of ordinary skill in the art having the benefit of this disclosure. Where the conferencing system terminal device 101 is configured with a keyboard and/or mouse, such as when the conferencing system terminal device 101 is configured as a computer, the keyboard and/or mouse can serve as the primary user interface 1002.

A block diagram schematic 1000 of the conferencing system terminal device 101 is also shown in FIG. 10. The block diagram schematic 1000 can be configured as a printed circuit board assembly disposed within the device housing of the conferencing system terminal device 101. Various components can be electrically coupled together by conductors, or a bus disposed along one or more printed circuit boards.

In one or more embodiments, the conferencing system terminal device 101 includes one or more processors 1003. In one embodiment, the one or more processors 1003 can include an application processor and, optionally, one or more auxiliary processors. One or both of the application processor or the auxiliary processor(s) can include one or more processors. One or both of the application processor or the auxiliary processor(s) can be a microprocessor, a group of processing components, one or more ASICs, programmable logic, or other type of processing device.

The application processor and the auxiliary processor(s) can be operable with the various components of the conferencing system terminal device 101. Each of the application processor and the auxiliary processor(s) can be configured to process and execute executable software code to perform the various functions of the conferencing system terminal device 101. A storage device, such as memory 1004, can optionally store the executable software code used by the one or more processors 1003 during operation.

The conferencing system terminal device 101 also includes a communication device 1005 that can be configured for wired or wireless communication with one or more other devices or networks. The networks can include a wide area network, a local area network, and/or personal area network. The communication device 1005 may also utilize wireless technology for communication, such as, but are not limited to, peer-to-peer or ad hoc communications such as HomeRF, Bluetooth and IEEE 802.11, and other forms of wireless communication such as infrared technology. The communication device 1005 can include wireless communication circuitry, one of a receiver, a transmitter, or transceiver, and one or more antennas.

In one embodiment, the one or more processors 1003 can be responsible for performing the primary functions of the conferencing system terminal device 101. For example, in one embodiment the one or more processors 1003 comprise one or more circuits operable with one or more user interface devices, which can include the display 1001, to engage in videoconferences by transmitting, receiving, and presenting images, video, or other presentation information. The executable software code used by the one or more processors 1003, including that associated with a videoconference application 1006, can be configured as one or more modules 1007 that are operable with the one or more processors 1003. Such modules 1007 can store instructions, control algorithms, logic steps, and so forth.

In one embodiment, the one or more processors 1003 are responsible for running the operating system environment of the conferencing system terminal device 101. The operating system environment can include a kernel and one or more drivers, and an application service layer, and an application layer. The operating system environment can be configured as executable code operating on one or more processors or control circuits of the conferencing system terminal device 101. The application layer can be responsible for executing application service modules. The application service modules may support one or more applications or “apps,” such as the videoconference application 1006. The applications of the application layer can be configured as clients of the application service layer to communicate with services through application program interfaces (APIs), messages, events, or other inter-process communication interfaces. Where auxiliary processors are used, they can be used to execute input/output functions, actuate user feedback devices, and so forth.

In one embodiment, the one or more processors 1003 may generate commands or execute control operations based upon user input received at the user interface 1002. Moreover, the one or more processors 1003 may process the received information alone or in combination with other data, such as the information stored in the memory 1004.

The conferencing system terminal device 101 can include one or more sensors 1008. The one or more sensors 1008 may include a microphone, camera, any of the sensors described above, an earpiece speaker, and/or a second loudspeaker. The one or more other sensors 1008 may also include touch actuator selection sensors, proximity sensors, a touch pad sensor, a touch screen sensor, a capacitive touch sensor, and one or more switches. Touch sensors may be used to indicate whether any of the user actuation targets present on the display 1001, including the user actuation targets presented in a prompt facilitating the commencement of a side call as described above, are being actuated. The other sensors 1008 can also include audio sensors and video sensors (such as a camera).

Other components 1009 operable with the one or more processors 1003 can include output components such as video outputs, audio outputs, and/or mechanical outputs. Examples of output components include audio outputs such as speaker port, earpiece speaker, or other alarms and/or buzzers and/or a mechanical output component such as vibrating or motion-based mechanisms. Still other components will be obvious to those of ordinary skill in the art having the benefit of this disclosure.

The other components 1009 can also include an image processor. The image processor can include hardware, executable code, and image processing executable code in one embodiment. The image processor can include, stored in memory 1004, basic image models, trained image models, or other modules that are used by the image processor to determine whether images captured by the imager include portions depicting obscured portions of a subject depicted in those images. In one embodiment, the image processor can include an object recognition engine. Regardless of the specific implementation utilized in the various embodiments, the image processor can access various image models to determine whether a person is engaged in an activity during a side call that may, for example, trigger the delivery of a video overlay in one or more embodiments.

To capture video during a videoconference, in one or more embodiments the conferencing system terminal device 101 includes an image capture device 1010 or another imager. The conferencing system terminal device 101 can optionally include a depth imager as well.

In one embodiment, the image capture device 1010 comprises a two-dimensional imager configured to receive at least one image of a person within an environment of the conferencing system terminal device 101. In one embodiment, the image capture device 1010 comprises a two-dimensional RGB imager. In another embodiment, the image capture device 1010 comprises an infrared imager. Other types of imagers suitable for use as the image capture device 1010 of the conferencing system terminal device 101 will be obvious to those of ordinary skill in the art having the benefit of this disclosure.

In one or more embodiments, the conferencing system terminal device 101 includes a side call management engine 1012. In one or more embodiments, the side call management engine 1012 can detect receipt of user input at the user interface 1002 defining a side call request. In one or more embodiments, in response to the side call request, the side call management engine 1012 can present a prompt allowing a selection of a subset of the plurality of remote electronic devices for inclusion in the side call while the videoconferencing application 1006 is engaged in a videoconference.

The side call management engine 1012 can further transmit a side call invitation to the subset of the plurality of remote electronic devices inviting them to the side call. The side call management engine 1012 can establish the side call during the videoconference without disconnecting the videoconferencing application 1006 from the videoconference. The side call management engine 1012 can allow the communication device 1005 to transmit audio signals from the conferencing system terminal device 101 to the subset of the plurality of remote electronic devices and can preclude the communication device 1005 from transmitting the audio signals to remote electronic device of the plurality of remote electronic devices omitted from inclusion in the subset of the plurality of remote electronic devices. The side call management engine 1012 can perform other operations described above with reference to FIGS. 2-8 as well.

In one or more embodiments, the conferencing system terminal device 101 also includes a video overlay generation engine 1011 as well. In one or more embodiments, the video overlay generation engine 1011 can generate the video feeds (804) as described above with reference to FIGS. 8-9. Illustrating by example, the video overlay generation engine 1011 can include a generative artificial intelligence manager that creates video overlays from real time images, in the form of animations, from training information, video libraries, image libraries, video captured during past videoconferences, or from user defined information. The video overlay generation engine 1011 can employ an artificial neural network or other similar technology that detects user activities during a side call to automatically generate video overlays that, when substituted for the video signals of the side call, conceal videoconference participant engagement in the side call as shown above in FIG. 9.

In one or more embodiments, the side call management engine 1012 and/or the video overlay generation engine 1011 can be operable with the one or more processors 1003. In some embodiments, the one or more processors 1003 can control the side call management engine 1012 and/or the video overlay generation engine 1011. In other embodiments, the side call management engine 1012 and/or the video overlay generation engine 1011 can operate independently from the one or more sensors 1008. The side call management engine 1012 and/or the video overlay generation engine 1011 can receive data from the various sensors. In one or more embodiments, the one or more processors 1003 are configured to perform the operations of the side call management engine 1012 and/or the video overlay generation engine 1011.

In one or more embodiments, the video overlay generation engine 1011 automatically applies video overlays in a video feed of a videoconference. In one or more embodiments, the video overlay generation engine 1011 automatically applies the video overlays in place of images depicting the side call participants during the videoconference. In one or more embodiments, the video overlay generation engine 1011 automatically inserts the video overlays prior to the communication device 1005 transmitting the images to other conferencing system terminal devices participating in the videoconference. Thereafter, the communication device 1005 can transmit the (now) video overlays to conceal participation in the side call. In other embodiments, the video overlay generation engine 1011 inserts the video overlays into images received from other conferencing system terminal devices participating in the videoconference.

The side call management engine 1012 and/or the video overlay generation engine 1011 can be operable with the various sensors 1008 to detect, infer, capture, and otherwise determine engagement in a side call and/or activities in a side call, examples of which include hysterical laughter, excessive crying, sleeping, mentioning names of videoconference participants not engaged in the side call, cursing, leaving the field of view of the image capture device 1010, generally talking smack, and so forth within an environment about the conferencing system terminal device 101 during a side call. For example, where included one embodiment of the side call management engine 1012 determines assessed contexts and frameworks using adjustable algorithms of context assessment employing information, data, and events. These assessments may be learned through repetitive data analysis. These assessments can be used to obtain additional contextual information when the contextual information changes in one or more embodiments. The side call management engine 1012 can comprise an artificial neural network or other similar technology in one or more embodiments.

It is to be understood that FIG. 10 is provided for illustrative purposes only and for illustrating components of one conferencing system terminal device 101 in accordance with embodiments of the disclosure and is not intended to be a complete schematic diagram of the various components required for a conferencing system terminal device. Therefore, other conferencing system terminal devices in accordance with embodiments of the disclosure may include various other components not shown in FIG. 10 or may include a combination of two or more components or a division of a particular component into two or more separate components, and still be within the scope of the present disclosure.

Turning now to FIG. 11, illustrated therein is one explanatory video conferencing system server complex 106 configured in accordance with one or more embodiments of the disclosure. An illustrative schematic block diagram 1100 is also shown in FIG. 11.

As with the block diagram schematic (1000) of FIG. 10, it is to be understood that the schematic block diagram 1100 of FIG. 11 is provided for illustrative purposes only and for illustrating components of one explanatory conferencing system server complex 106 configured in accordance with one or more embodiments of the disclosure. Accordingly, the components shown in either FIG. 10 or FIG. 11 are not intended to be complete schematic diagrams of the various components required for a particular device, as other devices configured in accordance with embodiments of the disclosure may include various other components not shown in FIG. 10 or FIG. 11. Alternatively, other server complexes or conferencing system terminal devices configured in accordance with embodiments of the disclosure or may include a combination of two or more components or a division of a particular component into two or more separate components, and still be within the scope of the present disclosure.

In one or more embodiments the conferencing system server complex 106 can be configured with performing processor-intensive methods, operations, steps, functions, or procedures associated with the presentation, actuation, and management of dynamic, automatic, and real time side calls, including the insertion of video overlays, during a videoconference. Illustrating by example, the conferencing system server complex 106 can be configured to receive one or more images 1101 in a video feed of a videoconference across a network 105.

A side call management engine 1103 can then, in response to user input received at a conferencing system terminal device in communication with the conferencing system server complex 106 initiating a communication operation at the conferencing system terminal device, can present a prompt at a user interface of the conferencing system terminal device allowing a selection of a subset of the plurality of remote electronic devices for a side call during a videoconference hosted by the videoconferencing engine 1109. A video overlay generation engine 1102 can even transmit a video overlay for an authorized user of a conferencing system terminal device engaged in a communication device to remote electronic device of the plurality of remote electronic devices engaged in the videoconference hosted by the videoconferencing engine 1109 that are omitted from inclusion in the remote electronic device to conceal participation of the authorized user in the side call as previously described.

In one or more embodiments, the conferencing system server complex 106 includes one or more memory devices 1106, and one or more user interface devices 1107, e.g., a display, a keyboard, a mouse, audio input devices, audio output devices, and alternate visual output devices. The conferencing system server complex 106 also includes a communication device 1105. These components can be operatively coupled together such that, for example, the one or more processors 1104 are operable with the one or more memory devices 1106, the one or more user interface devices 1107, the communication device 1105, and/or other components 1108 of the conferencing system server complex 106 in one or more embodiments.

The one or more processors 1104 can include a microprocessor, a group of processing components, one or more ASICs, programmable logic, or other type of processing device. The one or more processors 1104 can be configured to process and execute executable software code to perform the various functions of the conferencing system server complex 106.

The one or more memory devices 1106 can optionally store the executable software code used by the one or more processors 1104 in carrying out the operations of the videoconference system. The one or more memory devices 1106 may include either or both of static and dynamic memory components. The one or more memory devices 1106 can store both embedded software code and user data.

In one or more embodiments, the one or more processors 1104 can define one or more process engines. For instance, the software code stored within the one or more memory devices 1106 can embody program instructions and methods to operate the various functions of the conferencing system server complex 106, and also to execute software or firmware applications and modules such as the side call management engine 1103 and/or the video overlay generation engine 1102.

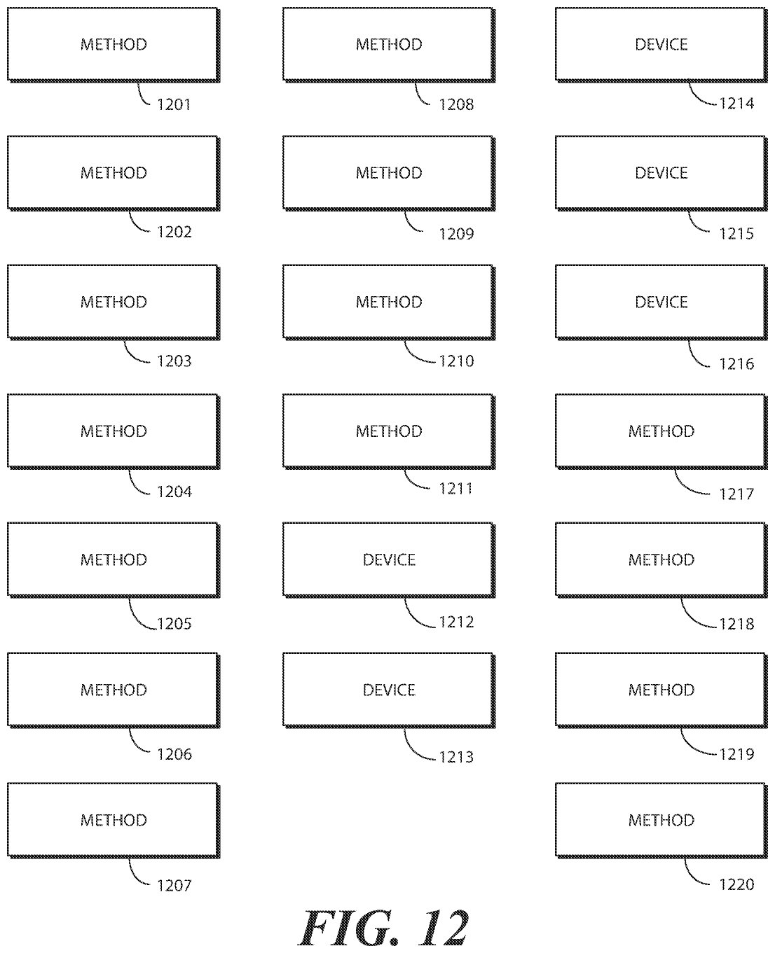

Turning now to FIG. 12, illustrated therein are various embodiments of the disclosure. The embodiments of FIG. 12 are shown as labeled boxes in FIG. 12 due to the fact that the individual components of these embodiments have been illustrated in detail in FIGS. 1-11, which precede FIG. 12. Accordingly, since these items have previously been illustrated and described, their repeated illustration is no longer essential for a proper understanding of these embodiments. Thus, the embodiments are shown as labeled boxes.

At 1201, a method in a conferencing system terminal device comprises detecting, with one or more processors during a videoconference, a communication device electronically in communication with a plurality of remote electronic devices engaged in the videoconference. At 1201, the method comprises receiving, with a user interface operable with the one or more processors, user input initiating a communication operation at the conferencing system terminal device. At 1201, in response to the user input, the method comprises presenting, with the one or more processors at the user interface, a prompt allowing a selection of a subset of the plurality of remote electronic devices for a side call during the videoconference.

At 1202, the user input of 1201 initiating the communication operation comprises a request for a microphone of the conferencing system terminal device to be unmuted. At 1203, the prompt of 1201 identifies one or more remote electronic devices of the plurality of remote electronic devices owned by owners belonging to single organization.

At 1204, the prompt of 1201 identifies one or more remote electronic devices of the plurality of remote electronic devices owned by employment superiors of an authorized user of the conferencing system terminal device. At 1205, the prompt of 1201 identifies one or more remote electronic devices of the plurality of remote electronic devices owned by employment subordinates of an authorized user of the conferencing system terminal device.

At 1206, the prompt of 1201 facilitates a shortcut operation to select the subset of the plurality of remote electronic devices for the side call during the videoconference. At 1207, the prompt of 1201 facilitates temporary suspension of the videoconference in an application portal facilitating the videoconference and being presented at the user interface while the side call is occurring.

At 1208, the method of 1201 further comprises receiving other user input selecting the subset of the plurality of remote electronic devices. At 1208, the method comprises establishing the side call with the subset of the plurality of remote electronic devices without disconnecting the videoconference.

At 1209, the method of 1208 further comprises, while the side call during the videoconference is occurring, allowing the communication device to transmit audio signals from the conferencing system terminal device to the subset of the plurality of remote electronic devices. At 1209, the method comprises precluding the communication device from transmitting the audio signals to remote electronic devices of the plurality of remote electronic devices omitted from inclusion in the subset of the plurality of remote electronic devices.

At 1210, the method of 1209 further comprises reducing an output volume of the videoconference from an audio output device of the conferencing system terminal device while the side call is occurring. At 1211, the method of 1210 further comprises delivering, with the communication device, a notification to the remote electronic devices of the plurality of remote electronic devices omitted from inclusion in the subset of the plurality of remote electronic devices indicating that the conferencing system terminal device is engaged in the side call during the videoconference.

At 1212, the method of 1210 further comprises precluding, by the one or more processors, the side call during the videoconference from being recorded. At 1213, the method of 1210 further comprises detecting, by the one or more processors, termination of the side call during the videoconference. At 1213, the method comprises increasing the output volume of the videoconference from the audio output device of the conferencing system terminal device. At 1213, the method comprises precluding the communication device from transmitting the audio signals to the plurality of remote electronic devices until an unmute request is received at the user interface.

At 1214, a conferencing system terminal device comprises a communication device in communication with a plurality of remote electronic devices during a videoconference. At 1214, the conferencing system terminal device comprises a user interface and one or more processors operable with the communication device and the user interface.

At 1214, the one or more processors detect receipt of a side call request at the user interface. At 1214, in response to the side call request, the one or more processors present a prompt allowing a selection of a subset of the plurality of remote electronic devices for inclusion in a side call during the videoconference.

At 1215, the one or more processors of 1214 further transmit a side call invitation to the subset of the plurality of remote electronic devices inviting them to the side call. At 1216, the one or more processors of 1215 establish the side call during the videoconference without disconnecting the conferencing system terminal device from the videoconference.

At 1217, the one or more processors of 1216 further cause the communication device to transmit a video overlay for an authorized user of the conferencing system terminal device to remote electronic devices of the plurality of remote electronic devices omitted from inclusion in the subset of the plurality of remote electronic devices concealing participation of the authorized user in the side call while the side call is occurring.

At 1218, a method in a conferencing system terminal device comprises receiving, by a communication device from a remote electronic device engaged in a videoconference while the conferencing system terminal device is engaged in the videoconference, a side call invitation. At 1218, the method comprises transmitting, by the communication device, a side call acceptance communication to the remote electronic device. At 1218, the method comprises establishing, by the communication device, a side call during the videoconference without disconnecting the conferencing system terminal device from the videoconference.

At 1219, the method of 1218 further comprises reducing an output volume of the videoconference from an audio output device of the conferencing system terminal device while the side call is occurring. At 1219, the method of 1218 further comprises allowing the communication device to transmit audio signals from the conferencing system terminal device to the remote electronic device. At 1219, the method of 1218 further comprises precluding the communication device from transmitting the audio signals to remote electronic devices other than the remote electronic device.

At 1220, the method of 1219 further comprises detecting, by one or more processors of the conferencing system terminal device, termination of the side call during the videoconference. At 1220, the method of 1219 comprises increasing the output volume of the videoconference from the audio output device of the conferencing system terminal device.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims.

Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

1. A method in a conferencing system terminal device, the method comprising:
detecting, with one or more processors during a videoconference, a communication device electronically in communication with a plurality of remote electronic devices engaged in the videoconference;
receiving, with a user interface operable with the one or more processors, user input requesting for a microphone of the conferencing system terminal device to be unmuted at the conferencing system terminal device; and
in response to the user input, presenting, with the one or more processors at the user interface, a prompt allowing a selection of a subset of the plurality of remote electronic devices for a side call during the videoconference.

2. The method of claim 1, wherein the prompt presents a first option allowing the subset of the plurality of remote electronic devices to be selected and a second option allowing the plurality of remote electronic devices engaged in the videoconference to be selected, further comprising replacing the prompt with another prompt listing the plurality of remote electronic devices in response to additional user input selecting the first option.

3. The method of claim 1, wherein the prompt identifies one or more remote electronic devices of the plurality of remote electronic devices owned by owners belonging to single organization.

4. The method of claim 1, wherein the prompt identifies one or more remote electronic devices of the plurality of remote electronic devices owned by employment superiors of an authorized user of the conferencing system terminal device.

5. The method of claim 1, wherein the prompt identifies one or more remote electronic devices of the plurality of remote electronic devices owned by employment subordinates of an authorized user of the conferencing system terminal device.

6. The method of claim 1, wherein the prompt facilitates a shortcut operation to select the subset of the plurality of remote electronic devices for the side call during the videoconference.

7. The method of claim 1, wherein the prompt facilitates temporary suspension of the videoconference in an application portal facilitating the videoconference and being presented at the user interface while the side call is occurring.

8. The method of claim 1, further comprising receiving other user input selecting the subset of the plurality of remote electronic devices and establishing the side call with the subset of the plurality of remote electronic devices without disconnecting the videoconference.

9. The method of claim 8, further comprising while the side call during the videoconference is occurring:
allowing the communication device to transmit audio signals from the conferencing system terminal device to the subset of the plurality of remote electronic devices; and
precluding the communication device from transmitting the audio signals to remote electronic devices of the plurality of remote electronic devices omitted from inclusion in the subset of the plurality of remote electronic devices.

10. The method of claim 9, further comprising reducing an output volume of the videoconference from an audio output device of the conferencing system terminal device while the side call is occurring.

11. The method of claim 10, further comprising delivering, with the communication device, a notification to the remote electronic devices of the plurality of remote electronic devices omitted from inclusion in the subset of the plurality of remote electronic devices indicating that the conferencing system terminal device is engaged in the side call during the videoconference.

12. The method of claim 10, further comprising precluding, by the one or more processors, the side call during the videoconference from being recorded.

13. The method of claim 10, further comprising:
detecting, by the one or more processors, termination of the side call during the videoconference; and
increasing the output volume of the videoconference from the audio output device of the conferencing system terminal device; and
precluding the communication device from transmitting the audio signals to the plurality of remote electronic devices until an unmute request is received at the user interface.

14. A conferencing system terminal device, comprising:
a communication device in communication with a plurality of remote electronic devices during a videoconference;
a user interface; and
one or more processors operable with the communication device and the user interface;
the one or more processors detecting receipt of a side call request at the user interface and, in response to the side call request, presenting a prompt allowing a selection of a subset of the plurality of remote electronic devices for inclusion in a side call during the videoconference.

15. The conferencing system terminal device of claim 14, the one or more processors further transmitting a side call invitation to the subset of the plurality of remote electronic devices inviting them to the side call.

16. The conferencing system terminal device of claim 15, the one or more processors establishing the side call during the videoconference without disconnecting the conferencing system terminal device from the videoconference.

17. The conferencing system terminal device of claim 16, the one or more processors further causing the communication device to transmit a video overlay for an authorized user of the conferencing system terminal device to remote electronic devices of the plurality of remote electronic devices omitted from inclusion in the subset of the plurality of remote electronic devices concealing participation of the authorized user in the side call while the side call is occurring.

18. A method in a conferencing system terminal device, the method comprising:
receiving, by a communication device from a remote electronic device engaged in a videoconference while the conferencing system terminal device is engaged in the videoconference, a side call invitation;
transmitting, by the communication device, a side call acceptance communication to the remote electronic device; and
establishing, by the communication device, a side call during the videoconference without disconnecting the conferencing system terminal device from the videoconference.

19. The method of claim 18, further comprising:
reducing an output volume of the videoconference from an audio output device of the conferencing system terminal device while the side call is occurring;
allowing the communication device to transmit audio signals from the conferencing system terminal device to the remote electronic device; and
precluding the communication device from transmitting the audio signals to remote electronic devices other than the remote electronic device.

20. The method of claim 19, further comprising:
detecting, by one or more processors of the conferencing system terminal device, termination of the side call during the videoconference; and
increasing the output volume of the videoconference from the audio output device of the conferencing system terminal device.
